(19) United States
(12) Patent Application Publication
(10) Pub. No.: US 2019/0348767 A1
(43) Pub. Date: Nov. 14, 2019

(54) LIGHTWEIGHT DEPLOYABLE APERTURE REFLECTARRAY ANTENNA REFLECTOR

(71) Applicant: MacDonald, Dettwiler and Associates Corporation, Ste-Anne-de-Bellevue (CA)

(72) Inventors: Eric AMYOTTE, Laval (CA); Steve LAROUCHE, St-Lazare (CA)

(73) Assignee: MacDonald, Dettwiler and Associates Corporation, Ste-Anne-de-Bellevue (CA)

(21) Appl. No.: 16/406,349

(22) Filed: May 8, 2019

Related U.S. Application Data
(60) Provisional application No. 62/668,304, filed on May 8, 2018.

(51) Int. Cl. H01Q 21/06; H01Q 1/08; H01Q 3/46; H01Q 21/00

(52) U.S. Cl. CPC H01Q 21/065; H01Q 21/0018; H01Q 3/46; H01Q 1/08

(57) ABSTRACT

A deployable aperture reflector for use in antennas to reflect an RF electromagnetic signal of a predetermined signal frequency band includes a deployable aperture structure deployable between a stowed aperture configuration and a deployed aperture configuration. The aperture structure includes a plurality of rigid members connecting to one another to support an RF reflective assembly when in the deployed aperture configuration. The RF reflective assembly includes a plurality of faceted cells adjacent one another that form an assembly mechanical shape approximating an optimal desired electrical surface shape. Each faceted cell includes at least one layer carrying RF resonant elements thereon that electrically compensate a difference between the assembly mechanical shape and the optimal desired electrical surface shape.

### CROSS REFERENCE TO RELATED APPLICATIONS

This application claims priority of U.S. Provisional Application for Patent No. 62/668,304 filed May 8, 2018, the content of which is incorporated herein by reference in its entirety.

### FIELD OF THE INVENTION

The present invention relates to the field of antennas, and is more particularly concerned with a lightweight deployable aperture reflectarray antenna reflector for use in spacecrafts and the like.

### BACKGROUND OF THE INVENTION

It is well known in the art of spacecraft antennas to use reflectors with large apertures to increase the RF (Radio-Frequency) performance of the antenna. When the size of such large aperture reflectors is larger than the launch vehicle shroud, they are usually in a stowed aperture configuration for spacecraft launch (in addition of the reflector boom support structure being also stowed against the spacecraft), and need to be unfurled in a deployed aperture configuration once on orbit (and in a previously deployed configuration of the reflector boom support structure). Deployable aperture reflectors are very complex in nature, with many movable parts required to achieve a desired precise as-deployed reflecting surface shapes. Common deployable reflector designs used in L-, C- and Ku-band applications generally employ a combination of rigid deploying members, hinges and a compliant RF reflective mesh which is tensioned to confer a parabolic shape. The shaping of such a design is typically limited to a global concave geometry with the possibility of coarse localized convex shapes. A reflector surface requires better surface accuracy for use at higher frequency bands (such as at Ka-band, V-band, etc.).

Such deployable apertures are time consuming and expensive to design and manufacture, especially for higher frequency band application, thus driving the need for more parts in order to achieve a finer surface definition when the aperture is in its final deployed aperture configuration, on orbit.

Reflectarrays have been proposed as a mean to make a planar mechanical surface yield the performance of an ideally shaped reflector (parabolic or other). The use of a planar reflector however results in significant bandwidth limitation due to the difference between the frequency sensitive resonant element (reflectarray) correction and that which would be achieved with the desired true time delay reflector optics.

Accordingly, there is a need for an improved deployable aperture reflectarray reflector for use in spacecrafts and the like.

### SUMMARY OF THE INVENTION

It is therefore a general object of the present invention to provide an improved deployable aperture reflectarray reflector to obviate the above-mentioned problems.

An advantage of the present invention is that the deployable aperture reflector, using the reflectarray technology, achieves the desired virtual theoretical electrical reflecting (or conducting) surface shape.

Another advantage of the present invention is that the deployable aperture reflectarray reflector allows for reduced overall weight, design and analysis times and costs, and manufacturing time and cost, including less moving parts for the aperture deployment than a conventional fine shaping of a reflecting surface, for a same electrical RF performance.

A further advantage of the present invention is that the deployable aperture reflectarray reflector allows for the use of simpler/coarser initial shapes of the different facetted cells that are electrically (RF-wise) refined with metallic (or electrically reflecting/conducting) patches.

Still another advantage of the present invention is that the deployable aperture reflectarray reflector typically includes a plurality of flexible cell surfaces composed of at least one generally RF transparent layer having electrically conductive patch elements thereon (reflectarray technology).

Yet another advantage of the present invention is that the deployable reflectarray reflector can be optimized to provide different performance characteristics for different frequency bands.

Yet a further advantage of the present invention is that the deployable reflectarray reflector can reproduce an equivalent refined optical shaping of multiple localized convex and concave geometries from a surface constituted of coarse flat surfaces (at least in one direction).

Still a further advantage of the present invention is that the reflective assembly is only tensioned into shape in its deployed configuration. It is flexible and compliant such that a minimum stowed volume can be achieved.

According to an aspect of the present invention there is provided a deployable aperture reflector for use in antennas to reflect an RF electromagnetic signal of a predetermined signal frequency band, said reflector comprising:
deployable aperture structure being deployable between a stowed aperture configuration and a deployed aperture configuration, said deployable aperture structure including a plurality of rigid members connecting to one another; and
an RF reflective assembly supported by said plurality of rigid members when in said deployed aperture configuration, said RF reflective assembly including a plurality of faceted cells adjacent one another and forming an assembly mechanical shape approximating a predetermined (or optimal desired) electrical surface shape, each said plurality of faceted cells including at least one layer carrying RF resonant elements thereon, said RF resonant elements electrically compensating a difference between said assembly mechanical shape and said predetermined electrical surface shape.

In one embodiment, the at least one layer includes one layer carrying the RF resonant elements thereon.

In one embodiment, the at least one layer includes one layer carrying the RF resonant elements on at least one of a front side and a rear side thereof.

In one embodiment, the at least one layer includes a plurality of layers, at least one of the plurality of layers carrying the RF resonant elements thereon.

In one embodiment, the at least one layer includes a front layer and a rear layer spaced from one another, said rear layer being flexible and generally reflective to the RF electromagnetic signal, said front layer being flexible and generally transparent to the RF electromagnetic signal, said front layer carrying the RF resonant elements thereon.

In one embodiment, each said faceted cell is substantially rectilinear in at least one direction, conveniently in a generally circumferential direction.

In one embodiment, each said faceted cell is substantially rectilinear in both a generally circumferential direction and a generally radial direction.

In one embodiment, each said faceted cell is substantially curved in at least one direction, conveniently in a generally radial direction.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is a schematic front perspective view of a deployable aperture reflectarray reflector in accordance with an embodiment of the present invention;

FIG. 2 is a schematic rear perspective view of the embodiment of FIG. 1;

FIG. 3 is a partially broken enlarged view taken along line 3 of FIG. 1;

FIG. 4 is a schematic rear perspective detail view of another embodiment of a deployable aperture reflectarray reflector of the present invention;

FIG. 5 is a schematic front perspective view of another embodiment of a deployable aperture reflectarray reflector of the present invention;

FIG. 6 is a partially broken enlarged section view taken along line 6-6 of FIG. 5;

FIG. 7 is a partially broken enlarged perspective view similar to FIG. 3, showing another embodiment of the present invention with an RF reflective assembly having a single layer; and

FIG. 8 is a broken enlarged schematic top plan view of an embodiment of a layer of a cell of the deployable aperture reflectarray reflectors of the present invention.

### DETAILED DESCRIPTION OF THE INVENTION

With reference to the annexed drawings the preferred embodiment of the present invention will be herein described for indicative purpose and by no means as of limitation.

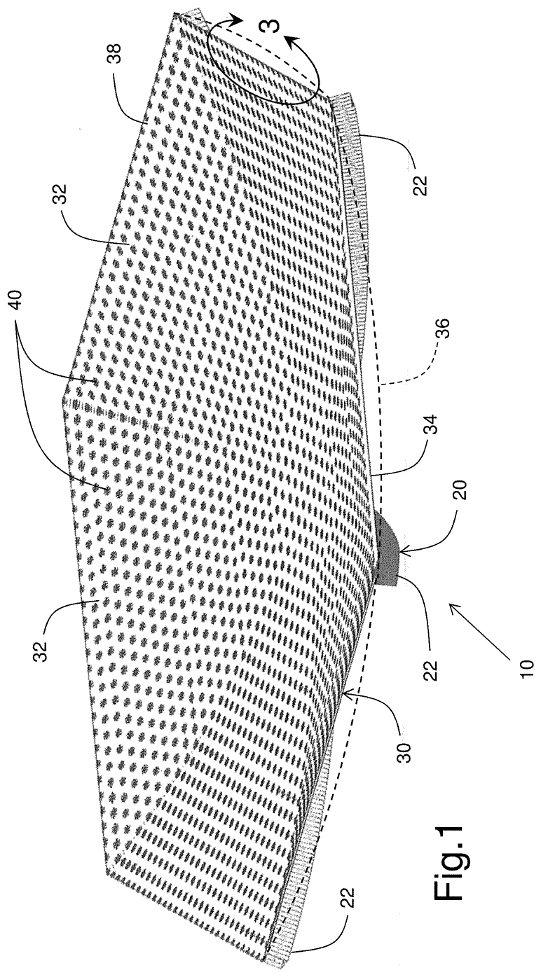

Referring to FIGS. 1 to 3, there is shown a deployable aperture reflector in accordance with an embodiment 10 of the present invention, typically for use in antennas onboard of spacecraft (not shown) or the like to reflect an RF (radio-frequency) electromagnetic signal of a predetermined signal frequency band. It is noted that the reflectors in the drawings are shown in the deployed aperture configuration only, and the deployment mechanisms (hinges, springs and the like) are also absent from the drawings since they do not form part of the present invention. Furthermore, the attachment of the different parts to one another is also not illustrated and many different link elements known in the art can be used.

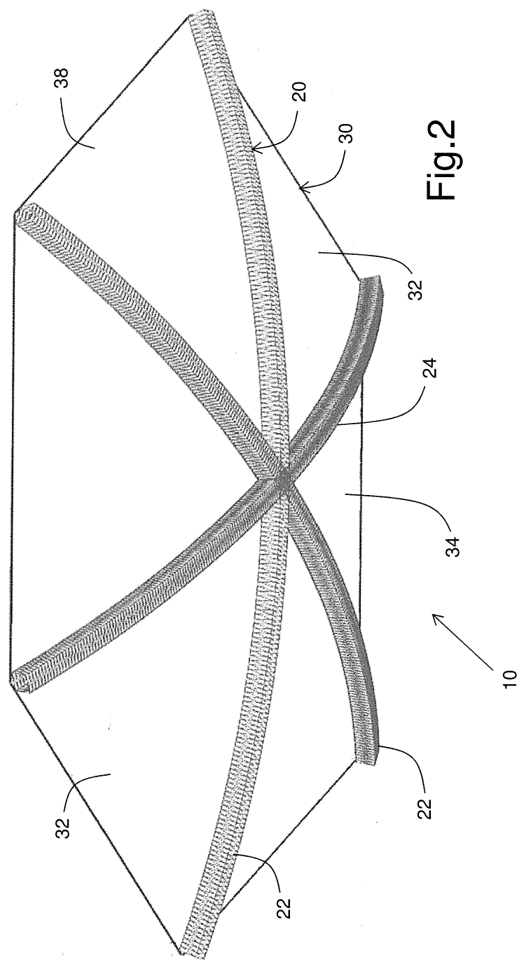

The embodiment of FIG. 1 typically includes a deployable aperture structure 20 being deployable, similarly to an umbrella or a wrap rib system as possible non-limiting examples for the present embodiment, between a stowed aperture configuration (not shown) and a deployed aperture configuration depicted in FIGS. 1 and 2. The deployable aperture structure 20 includes a plurality of rigid members 22 connecting to one another and arranged into a pattern 24 (best seen in FIG. 2), such as a radial pattern in this case, with the rigid members 22 or ribs being essentially curved in the radial direction in the present embodiment 10. An RF reflective assembly 30 is supported by the rigid members 22 when in the deployed aperture configuration. The RF reflective assembly 30 typically includes a plurality of faceted cells 32 adjacent one another and which form (or define) an assembly mechanical shape 34 that approximates an optimal desired or predetermined electrical surface shape 36 (schematically shown in dotted lines). Each faceted cell 32 is formed with at least one layer 38 of a typically flexible material, and two in the current embodiment 10, a front layer 38f and a rear layer 38r spaced from one another. The gap between adjacent layers 38 could be maintained using spacers (not shown) or the like, or any other spacing mechanisms that would typically have a negligible effect on the RF electrical performance of the RF reflective assembly 30.

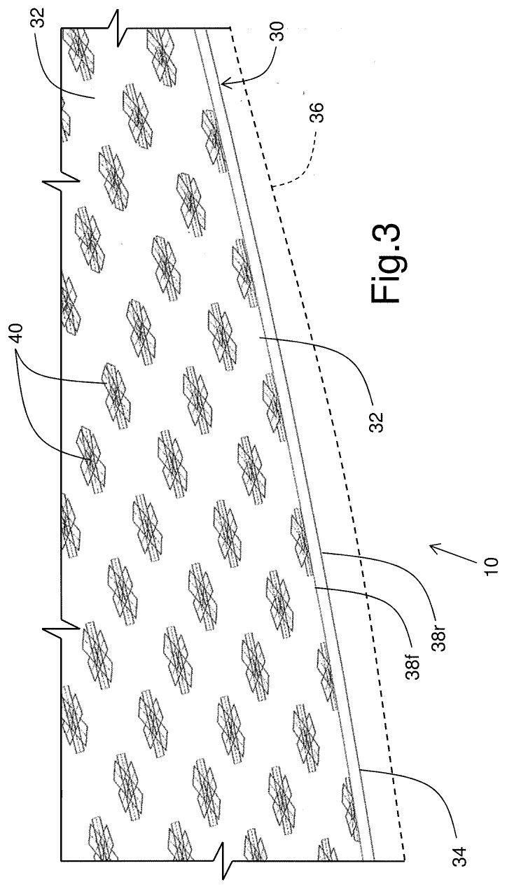

Since the optimal desired electrical surface shape 36 is usually curved in all directions, while the surfaces of each of the faceted cells 32 are generally rectilinear into at least one direction (such as the circumferential direction in the embodiment of FIGS. 1-3 as the cells 32 are stretched or tensioned between adjacent rigid members 22) relative to a geometrical pointing axis of the RF reflective assembly 30, each faceted cell 32 carries RF resonant elements 40 thereon. The RF resonant elements 40 essentially electrically compensate a difference between the assembly mechanical shape 34 and the optimal desired electrical surface shape 36. As better seen in FIG. 3, the front layer 38f includes a generally RF transparent material carrying thereon the RF resonant elements 40 (or often referred to as patches) made out of electrically reflecting material. The electrically reflecting material can, for example, and by no means of limitation, be a material attached, stitched, painted, deposited (under vacuum and/or with an electro-chemical process), plated or bonded thereon. The rear layer 38r generally includes an electrically reflecting material thereon to act as an electrical grounding layer.

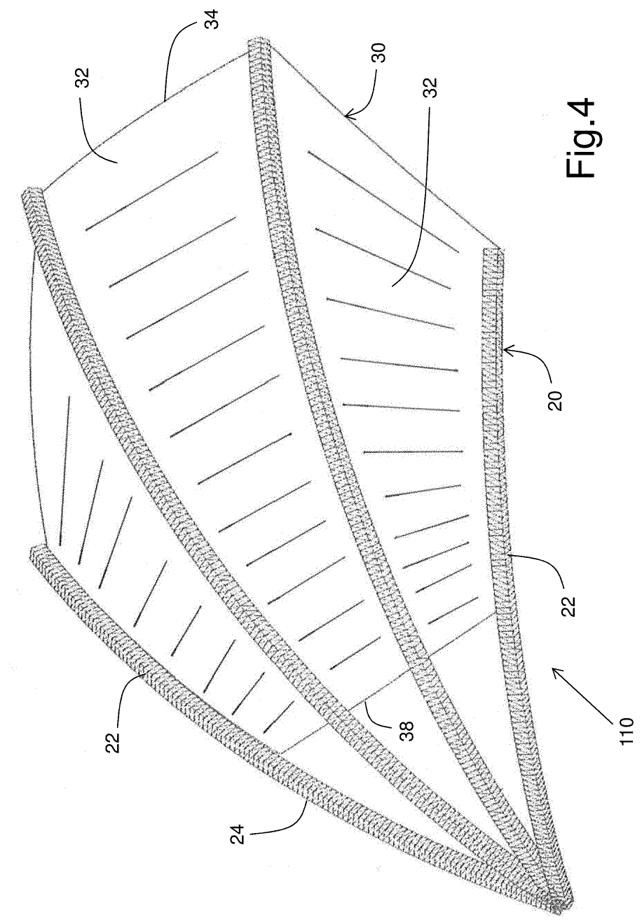

Now referring more specifically to FIG. 4, there is shown a deployable aperture reflector in accordance with a second embodiment 110 of the present invention which could deploy similarly to a fan. The rigid members 22 are also shown as being essentially curved in the radial direction, and the different cells 32 of the RF reflective assembly 30, being generally rectilinear in the circumferential direction, form a mechanical shape 34 approximating a portion of a circular surface such as paraboloid, a hyperboloid or the like.

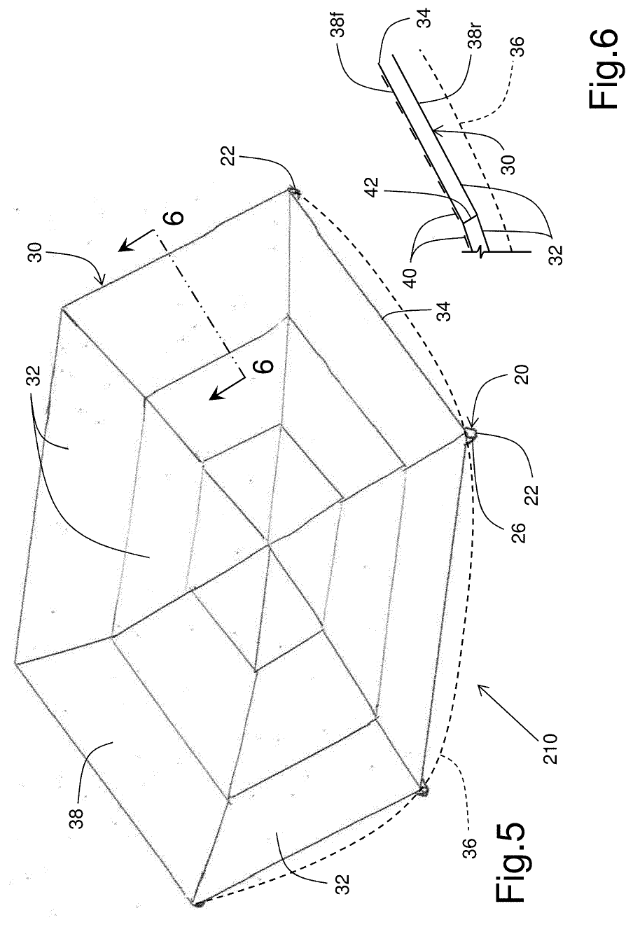

In FIGS. 5 and 6, there is a deployable aperture reflector in accordance with a second embodiment 210 of the present invention that is similar to the first embodiment 10, in which each rigid member 22 includes a plurality of rectilinear sections 26 (instead of a curved member 22) positioned in an end-to-end configuration, and with each faceted cell 32 being generally flat (or generally rectilinear into orthogonal directions, namely generally radial and circumferential directions), with the RF resonant elements 40 (shown in FIG. 6 only).

When a plurality of layers 38 are used to form the faceted cells 32 of the RF reflective assembly 30, it could be considered to use some, preferably RF transparent, spacers 42 between adjacent layers 38 to control the distance there between.

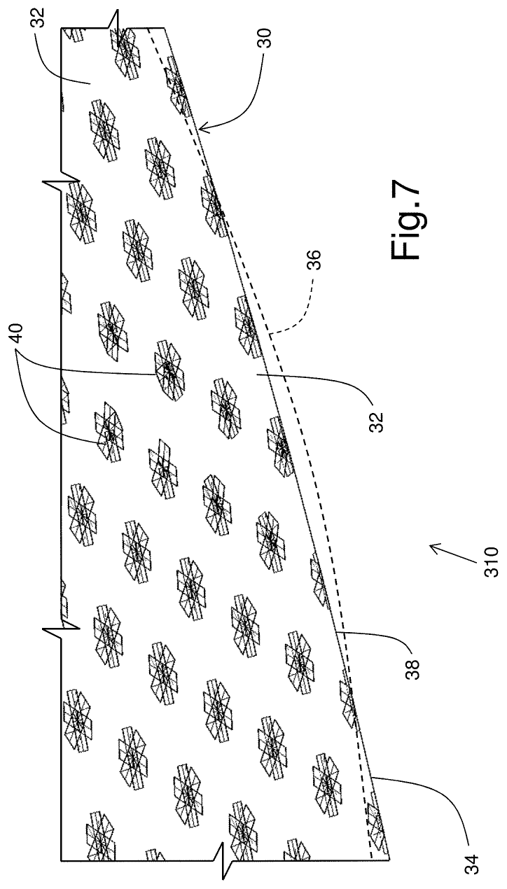

As shown in FIG. 7, another embodiment 310 of a deployable aperture reflector in accordance with the present invention includes a single layer 38 of each facetted cell 32 of the RF reflective assembly 30 that carries the RF resonant elements 40 thereon (note that although the elements 40 seems similar to the ones of FIG. 3, they could also be totally different in size, shape and spreading over the cells 32). Here again, the elements 40 compensate for the difference between the assembly mechanical shape 34 of the RF reflective assembly 30 and the predetermined electrical surface shape 36 (schematically illustrated in stippled line).

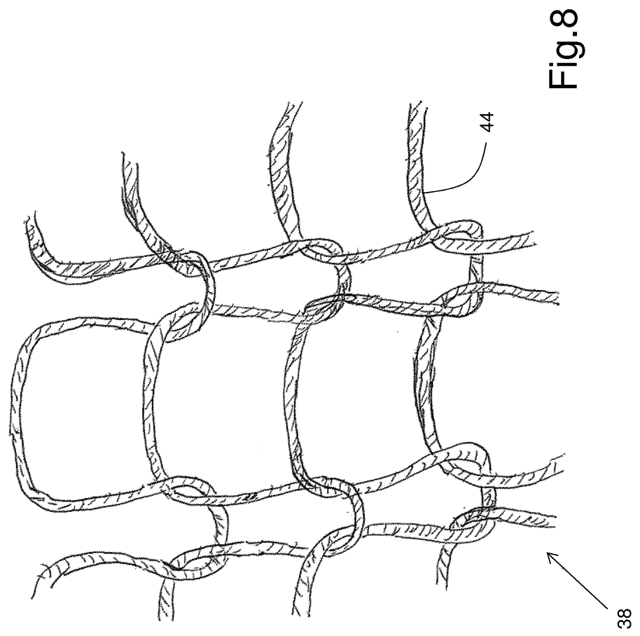

As illustrated in FIG. 8, each layer 38 of a faceted cell could be made with a knitted mesh material 44, typically including metallic material (with any organized or even chaotic layout arrangement), that is flexible enough to remain as flat as possible, when stretched or tensioned, without generating small wrinkles that would not be acceptable to the RF performance of the antenna. A person skilled in the art would readily understand that many other types of materials (dielectric sheets, fibers, etc.) could be considered without departing from the scope of the present invention.

In one embodiment, the at least one layer includes a plurality of layers, with at least one of the plurality of layers carrying the RF resonant elements thereon.

In one embodiment, the at least one layer includes a front layer 38f and a rear layer 38r spaced from one another. The rear layer 38r could be flexible and generally reflective to the RF electromagnetic signal, while the front layer 38f would be flexible and generally transparent to the RF electromagnetic signal, with the front layer 38f having or carrying the RF resonant elements 40 thereon.

Although not illustrated, one skilled in the art would readily realize that, without departing from the scope of the present invention, when a plurality of layers 38 are considered for each faceted cell 32, at least one of the plurality of layers 38 carries the RF resonant elements 40 thereon. Also, a same layer 38 could have patches 40 on at least one of a front side and a rear side thereof.

Although the present invention has been described with a certain degree of particularity, it is to be understood that the disclosure has been made by way of example only and that the present invention is not limited to the features of the embodiments described and illustrated herein, but includes all variations and modifications within the scope of the invention as hereinabove described and hereinafter claimed.

We claim:

1. A deployable aperture reflector for use in antennas to reflect an RF electromagnetic signal of a predetermined signal frequency band, said reflector comprising:
a deployable aperture structure being deployable between a stowed aperture configuration and a deployed aperture configuration, said deployable aperture structure including a plurality of rigid members connecting to one another; and
an RF reflective assembly supported by said plurality of rigid members when in said deployed aperture configuration, said RF reflective assembly including a plurality of faceted cells adjacent one another and forming an assembly mechanical shape approximating a predetermined electrical surface shape, each said plurality of faceted cells including at least one layer carrying RF resonant elements thereon, said RF resonant elements electrically compensating a difference between said assembly mechanical shape and said predetermined electrical surface shape.

2. The reflector of claim 1, wherein the at least one layer includes one layer carrying the RF resonant elements thereon.

3. The reflector of claim 1, wherein the at least one layer includes one layer carrying the RF resonant elements on at least one of a front side and a rear side thereof.

4. The reflector of claim 1, wherein the at least one layer includes a plurality of layers, at least one of the plurality of layers carrying the RF resonant elements thereon.

5. The reflector of claim 1, wherein the at least one layer includes a front layer and a rear layer spaced from one another, said rear layer being flexible and generally reflective to the RF electromagnetic signal, said front layer being flexible and generally transparent to the RF electromagnetic signal, said front layer carrying the RF resonant elements thereon.

6. The reflector of claim 1, wherein each said faceted cell is substantially rectilinear in at least one direction.

7. The reflector of claim 6, wherein each said faceted cell is substantially rectilinear in a generally circumferential direction.

8. The reflector of claim 6, wherein each said faceted cell is substantially rectilinear in both a generally circumferential direction and a generally radial direction.

9. The reflector of claim 1, wherein each said faceted cell is substantially curved in at least one direction.

10. The reflector of claim 9, wherein each said faceted cell is substantially curved in a generally radial direction.
